(19) United States
(12) Patent Application Publication
(10) Pub. No.: US 2024/0110111 A1
(43) Pub. Date: Apr. 4, 2024

(54) PROCESS FOR REPLACEMENT OF FOSSIL FUELS IN FIRING OF ROTARY LIME KILNS

(71) Applicant: Highbury Energy Inc., Victoria (CA)

(72) Inventors: Yong Hua LI, Vancouver (CA); Wei WANG, Vancouver (CA); Alan Paul WATKINSON, Vancouver (CA)

(21) Appl. No.: 18/374,636

(22) Filed: Sep. 28, 2023

Related U.S. Application Data
(60) Provisional application No. 63/412,337, filed on Sep. 30, 2022.

(51) Int. Cl. C10J 3/56; B01D 45/16; B01D 46/02; B01D 47/00; B01D 50/10; B01D 53/14; B01D 53/18; C04B 2/10; C04B 14/28; C10B 49/22; C10B 53/02; F23K 1/04

(52) U.S. Cl. CPC C10J 3/56; B01D 45/16; B01D 46/02; B01D 47/00; B01D 50/10; B01D 53/1468; B01D 53/1475; B01D 53/18; C04B 2/106; C04B 14/28; C10B 49/22; C10B 53/02; F23K 1/04; F23K 2201/20; F27B 7/10

(57) ABSTRACT

A method and system for the generation of a medium-Btu, clean and renewable fuel gas to replace fossil fuels in existing lime kilns with minimal retrofitting without significantly compromising the kiln capacity. A steam-blown dual fluidized bed gasifier produces renewable fuel gas from a carbonaceous feedstock such as woody biomass. A gas cleanup process purifies the raw fuel gas, resulting in a clean fuel gas for mitigation of lime contamination and environmental issues. The adiabatic flame temperature and flue gas volume/GJ for the combustion of the renewable fuel gas are similar to values for natural gas, making retrofitting of fossil fuel-fired lime kilns relatively straightforward.

### TECHNICAL FIELD OF THE INVENTION

This application relates to the system and methods for fueling lime kilns with a clean and renewable fuel gas generated from steam-blown indirect gasification of woody biomass to replace fossil fuel systems in existing or newly built kilns. The Invention can be applied to both lime mud kilns in the kraft pulp industry and pebble lime kilns in the chemical industry.

### BACKGROUND TO THE INVENTION

Industrial Furnaces

A large industrial furnace system generally consists of piping for the fuel and air (primary and secondary) coming to a burner, a control system to adjust the ratio of air to fuel, an ignition system, an insulated chamber in which the combustion takes place, and a heat exchanger system in which the heat is transferred from the flame and flue gases to the desired recipient stream, and a heat recovery section to minimize heat lost to the surroundings. Such furnaces are typically in the range >20 MW.

Natural Gas, which is a common fuel for these large industrial furnaces, can have a range of properties, and allowable impurities, set by pipeline regulations.

Reduction of CO₂ emissions from industrial kilns, furnaces and boilers can be accomplished by replacing fossil fuels such as natural gas, fuel oil, coal, or petroleum coke with renewable manufactured fuel gases. This can be done either by designing appropriate equipment for new industrial processes or by retrofitting fuel supply systems and other equipment in existing processes. For retrofit applications, when gaseous fuels such as natural gas are replaced by renewable manufactured gaseous fuels, the replacement fuel gas mixture should have certain properties such that the fuel system can be retrofitted without also changing the industrial furnace system itself. These properties include:
(i) a sufficiently high heating value, preferably a lower heating value (LHV) of greater than 9 MJ/Nm³. In comparison, natural gas has an LHV of 35-38 MJ/Nm³. For manufactured gases with combustible content of renewable H₂, CO, CH₄, and C2+, the LHV is a strong function of the N₂, CO₂ and moisture contents, which are inert in terms of heating value.
(ii) a high flame temperature for use in high-temperature rotary kilns such as lime kilns, cement kilns, or boilers, where heat transfer occurs mainly by radiation. A high calculated adiabatic flame temperature is desirable, which is a strong function of its concentration of combustible species such as CH₄, C2+, CO and H₂.
(iii) a flue gas volume, m³/GJ of the heating value of replacement fuel, that is similar to that of the natural gas, which will reduce costs of the retrofitting, as minimal changes will be necessary for flue gas handling down-stream of the burner system.
(iv) the raw gas should be cleaned to the extent that impurities arising from the biomass or heat carrier neither contaminate nor otherwise adversely affect the downstream kiln process

Calcination of CaCO₃

Lime production is an energy-intensive process in modern kraft pulp mills, mainly due to the calcination reaction that requires a high energy consumption to treat the calcium carbonate mud, a mixture of precipitated CaCO₃ and water which arises in the spent liquor recovery loop. Water is driven off the mud, and the CaCO₃ is decomposed into calcium oxide and carbon dioxide following Equation (1) [1].

In the chemical industry, CaO is produced from quarried solid limestone (CaCO₃), which is crushed, and the dry solid is heated to a high temperature where Reaction (1) also occurs.

CaCO₃₍ₛ₎+ΔH_{R}→CaO₍ₛ₎+CO_{2(g)} Equation (1)

where ΔH_{R}=3.17MJ/kgCaO at T=900° C.

In both cases, the reaction is carried out in a rotary lime kiln.

In Kraft pulp mills, calcination is an integral part of the chemical recovery system where lime mud, which contains around 70% precipitated CaCO₃ and 30% moisture [2], is fed to the kiln. Although the theoretical heat necessary for the calcination reaction is 3.17 MJ/kg CaO, the actual energy consumption is 6-10 MJ/kg CaO in industrial practice [1, 3]. Lime kilns are typically the only part of the kraft pulping process that consumes fossil fuels, mainly natural gas or fuel oil [4]. In 2009, approximately two-thirds of the kilns in the United States and Canada burned natural gas, and one-third burned fuel oil [3] to provide the heat for the process.

A rotary lime kiln (FIG. 1) is a large (2-4 m dia. X 50-120 m long [5], inclined refractory-lined cylinder) counter-current processing unit in which the flow of solids is aided by the slow rotation of the shell to move down the inclined reactor counter-current to the flow of hot flue gas from the stationary burner mounted at the lower end. The product CaO exits below the flame zone.

In the pulp industry, CO₂ emissions from fossil fuel combustion in lime kilns are significant, estimated at roughly 400 kg CO₂ eq/tonne of lime [6, 7]. Biomass gasification has gained interest due to the increasing demand for greenhouse gas (GHG) emission reduction, fossil fuel replacement and utilization of biomass residue [8]. It is reported that switching from fossil fuels to bioenergy in lime kilns could contribute to a 10% reduction in GHG emissions in European kraft pulp mills [6].

In the pebble lime industry, which serves the lime needs of the steel, chemical and water treatment industries, switching from fossil fuels to renewable fuels has similar benefits in terms of GHG reduction/tonne CaO produced. As very little water is evaporated, the fuel consumption in the calcination process is lower than in pulp mill kilns.

Prior Art and Drawbacks

For pulp mill lime kiln applications, the Prior Art makes use of direct gasification with air as the oxidizer, producing syngas with high N₂ (40-50% vol.) and moisture (˜15% vol.) content, resulting in low calorific values gases (LHV 3-6 MJ/Nm³) compared to natural gas (LHV 35-38 MJ/Nm³).

At ambient burner inlet fuel gas and air temperatures, the combustion of a typical low-Btu syngas of the Prior Art delivers an adiabatic flame temperature of about 1,523° C., which is significantly below that of natural gas and below the minimum temperature requirement in lime kilns (1,750° C.). In the Prior Art, additional sensible heat is provided by directly transferring the syngas from the gasifier to the kiln burner at high temperatures (˜700° C.) and pre-heating the kiln combustion air to 300-400° C. to meet the adiabatic flame temperature requirements.

Raw product gases from biomass gasifiers contain a number of impurities: fine particles of ash, char, and heat carrier; tar species which can become liquid droplets at temperatures around 400° C., and gaseous chemical species of sulphur, nitrogen and chlorine, and unreacted steam. These species generally must be removed in gas cleaning operations.

The need to transfer hot (˜700° C.) syngas to the kiln burner brings significant obstacles to the purification of the syngas as there are few syngas cleanup methods that can be used at 700° C. except cyclones, which cannot consistently clean gas of the finer particulates from biomass ash and heat carrier materials. These particulates thus enter the kiln and bring non-process elements (NPEs), such as Si, Al, Fe, Mg, K, and P containing species, to the kiln and contaminate the lime circuit. The NPE issues are even more severe if the gasifier is fed with high ash content biomass such as bark. In the Prior Art, newly purchased lime is used to continuously replace part of the contaminated lime which is purged from the system to maintain a low NPE level in the lime circuit.

High-temperature syngas also dictates that wet scrubbers cannot be applied to remove tars and NH₃ from raw syngas. Tars will condense in cooler regions of the gas passage, clogging devices (such as valves) and causing shut-downs [9]. NH₃ in the raw syngas can often lead to high NOx emissions in the flue gas, causing environmental issues. High NOx emissions with syngas are widely reported, but no solutions are present in the Prior Art [10].

In the Prior Art, heating processes such as biomass drying and kiln combustion air pre-heating consume significant energy. Since the syngas is delivered to the kiln burner at high temperatures and no excess heat is available, fossil fuels or part of the feed biomass are generally used to provide energy for these heating processes, causing increasing operational costs and GHG emissions.

Most (if not all) lime kilns in North America still use fossil fuels, and retrofitting is thus essential for many kilns in transition to renewable fuels. By applying the Prior Art, in addition to providing the gasification system, two major types of retrofitting are required to accommodate the low-Btu syngas: retrofitting of the fuel gas pipelines and of the kiln flue gas system.

A low calorific value in a fuel gas (MJ/m³) dictates that more fuel volumetric flow (m³/s) is needed to achieve the same capacity (MJ/s), leading to a significant increase in the gas flow rates in the flue gas system (Table 1). Higher flue gas flow rates may require upscaling the induced draft (ID) fans and/or the post-fan wet scrubber (FIG. 1). Besides, high flue gas velocities would lead to increasing dusting issues in the kiln and increasing explosion risk during the maintenance. Reducing the syngas flow rate is a solution to mitigate the flue gas system issues and was reported in some retrofitting projects. However, the original kiln capacity with natural gas cannot be achieved. Transportation of syngas at high temperatures entails using high-grade metal piping to avoid material risks of failures along the fuel gas path. All the above retrofitting needs increase the required capital investment.

Furthermore, high syngas temperature at the kiln burner requires the gasifier system must be located physically close enough to the lime kiln to minimize heat losses. This technology may be precluded for an existing kraft mill due to a lack of available space adjacent to the lime kiln to locate the gasification facility, which is also a major consideration for the retrofitting of existing lime kilns.

In Prior Art, co-firing syngas with natural gas in the lime kiln is widely observed to mitigate some of the issues arising from the low-Btu syngas. However, the complete replacement of fossil fuels will not be achieved in these cases.

Table 1 summarizes selected drawbacks of the Prior Art with low-Btu gas.

TABLE 1
Drawbacks of the Prior Art with Low-Btu Gas

| Prior Art | |
|---|---|
| Low BTU | |
| Gas Solution | Drawback |
| The syngas is | 1. Lack of low-temperature gas cleanup methods, |
| delivered to | causing: |
| the kiln burner | 1.1 Ash and dust enter the kiln with syngas and |
| at high | cause NPE contamination of lime |
| temperatures | 1.2 High syngas moisture content (10-15%) |
| (~700° C.) | resulting in even lower calorific value and higher |
| to raise the | flue gas per GJ input |
| flame | 1.3 Tar condensation and clogging in the gas |
| temperature | passage |
| | 1.4 High syngas NH₃ concentration leads to high |
| | NOx emissions when syngas is burned |
| | 2. Material risks due to the high-temperature |
| | transportation of syngas, requiring high-grade |
| | materials |
| | 3. Heat loss on the gas piping to the kiln, |
| | requiring minimizing the distance between the |
| | gasifier and burner |
| | 4. No spare heat available from the hot syngas |
| | for system use, such as feed dryer and kiln air |
| | preheating, resulting in additional energy |
| | consumption from fossil fuel or feed |
| Higher flue gas | 5. Require Upscaling of the kiln ID fan and dust |
| volumetric flow | scrubber, or reduced syngas flow rate and kiln |
| rates than with | capacity |
| natural gas | 6. Dusting issues in the kiln due to high flue gas |
| | flow rate |
| Co-firing with | 7. Obstacles to 100% replacement of natural gas, |
| natural gas is | increasing GHG emissions |
| common to meet | |
| the kiln capacity | |
| requirement | |

Processes of the Prior Art

U.S. Pat. Nos. 9,643,885 and 10,676,395, to Andritz Oy, (incorporated herein by reference) focus on Drawback #4. An arrangement is proposed with a conduit to lead the hot air from the lime kiln into the gasifier to preheat the gasification air with heat from the lime discharged from the rotary kiln. This patent improves the lime kilns fueled with syngas from woody biomass air gasification. The inventors claim that in the existing syngas-fueled lime kilns, cold air used in the gasifier is preheated to around 300° C. or higher using the hot syngas, thus decreasing the temperature of the syngas to the burner. This temperature decrease directly reduces the temperature of the flame in the kiln. Alternatively, the combustion air can be heated with steam exchangers, consuming valuable energy. The inventors also claim that the secondary air requirement for the syngas-fueled lime kilns is smaller than that for the natural gas or oil-fueled lime kilns. The new configuration uses an air duct to take some air from the firing end of the kiln (e.g., the secondary air used in the kiln, which is heated by the hot discharged lime). This secondary air in the firing end of the kiln is typically over 300° C. It is claimed that the air taken from the secondary air is about 20% of the total secondary air in the lime kiln.

U.S. Pat. No. 8,882,493, to Nexterra Systems Corp, (incorporated herein by reference) proposes a solution to Drawback #3. A booster burner configuration is proposed between the gasifier and the syngas kiln burner to increase the syngas temperature. In the fixed bed updraft gasifier, the typical syngas temperature at the gasifier exit is 180-480° C. or 315-370° C. in some embodiments. The syngas flame temperature is too low for some applications due to low heating value, particularly when the biomass fed to the gasifier has a high moisture content. Thus the tars and other heavier fractions should be retained in the syngas to improve its heating value. Tars tend to condense below 360° C. and crack over 510-540° C. The invention aims to control the syngas temperature during transportation to the kiln to a value between the tar condensation temperature and tar cracking temperature by using a booster burner in the syngas transportation pathway. The invention also includes a temperature monitor and control system to adjust the booster burner to accommodate the syngas heating value and composition changes due to the changing feedstock moisture. The booster burner may burn a fossil fuel such as natural gas, propane or oil, which limits the reduction of GHG emissions that can be achieved.

US patent publication 2009/0311644 to Metso Power Oy (incorporated herein by reference) proposes a solution to Drawback #1.1 by using calcium compounds as bed material in the gasifier to replace dolomite or sand in known solutions to prevent NPE contamination to the lime from the entrained gasifier bed material to the kiln. The inventors claim that dolomite or sand is used as bed material in gasifiers in known solutions. These entrained bed materials pass through cyclones and enter the lime kiln, causing lime mud and/or the end product fouling. A part of the ash ends up in the lime kiln. The proposed solution uses calcium compounds as bed materials for a CFB gasifier to decrease the undesired material accumulating and improve the purity of the lime kiln end product when using syngas as fuel. In an application, a part of the lime mud is fed to the gasifier. Calcium species as bed material can incur higher costs than using other bed materials.

### BRIEF SUMMARY OF THE INVENTION

Lime kilns in Canada (North America) are presently fired using fossil fuels. For a given lime kiln in kraft process pulp mills or in chemical lime facilities, a renewable fuel gas (RFG) should replace at least some, and preferably 100% of the natural gas or oil flow presently used.

The RFG should preferably have at least one or more of the following features to overcome the drawbacks of the Prior Art using low-Btu gas from biomass gasification by air:
The RFG should preferably have an adiabatic flame temperature when fired into the kiln that is substantially equal to that of the fossil fuel (natural gas), without the need for restrictive heating of the RFG and the air (primary and secondary) to the kiln burner to temperatures of around 700° C. and 350° C., respectively (or in other words, an RFG that relies solely on combustion heat, and not on sensible heat for its effectiveness). This feature will aid in addressing Drawbacks 1-4.
When burnt in the lime kiln, the RFG should have a flue gas volume/GJ equal to or less than that for the natural gas it is replacing, in order to avoid increased dust elutriation of CaO from the kiln. This feature will aid in addressing Drawbacks 5-6.
The replacement of fossil fuels should preferably be a complete replacement of the traditional fossil fuel with the RFG, without reducing the kiln capacity or requiring significant retrofitting so that the GHG emissions reduction is maximized. This feature will aid in addressing Drawback 7.

A method and system have been invented to produce a clean and renewable fuel gas to completely replace fossil fuels in lime kilns and improve the integrated gasification and lime kiln system with a process free of the drawbacks associated with the Prior Art.

A medium calorific value syngas (9-13 MJ/m³ LHV), with roughly twice the calorific value of the low-Btu gases in the Prior Art, is generated from a steam-blown indirect gasification process. Gasification conditions are set to generate a product gas that, after the specified cleaning treatment, has an adiabatic flame temperature similar to that of natural gas, and will thus have a high flame temperature in the kiln. It will also have a flue gas volume/GJ that does not exceed that of natural gas.

A combination of high and low temperature raw syngas deep cleaning steps allows for the removal of one or more of:
particulates that could otherwise enter the kiln, build up in the lime circuit as NPEs and contaminate the lime product,
tars, that would otherwise cause operating problems such as plugging in the pipeline or in the downstream burner or other equipment,
moisture which would detrimentally affect the gas heating value and adiabatic flame temperature,
NH₃ that would cause excessive NOx emissions in the lime kiln stack,
Chlorides generated in the gasification of salty biomass,
H₂S that would contaminate the product In pellet lime kiln applications*,
CO₂ that will further raise the adiabatic flame temperature and LHV, reduce the flue gas volume, and may lower the carbon intensity of the RFG.
   * Note that sulfur pick-up by the lime is not a drawback in kraft pulp mill lime kilns.

The firing of the lime kiln with ambient temperature clean, renewable fuel gas of the invention produces similar adiabatic flame temperatures and kiln flue-gas flowrates as for natural gas, obviating the need for significant retrofitting of the flue gas system and pipeline materials of existing kilns, and relieving the necessity of having the gasifier and lime kiln adjacent to each other to conserve heat.

By fueling the kiln with the renewable fuel gas of this invention, the main drawbacks of the Prior Art are overcome. Complete replacement of natural gas and maintaining the original kiln production capacity can be achieved with minimum retrofitting of the existing kilns.

According to one embodiment of the present invention is provided a system for manufacturing of a renewable fuel gas for use in a rotary lime kiln or in a limestone calcination plant, comprising: a dual bed gasification apparatus, said dual bed gasification apparatus comprising: a gasifier providing partial oxidation of a biomass to generate a hot raw syngas and char; a char combustor connected to the gasifier generating a char combustor flue gas and providing energy for the gasification process; a heat carrier circulating between the said gasifier and char combustor to transfer heat from the char combustor to the gasifier; at least one gasifier cyclone, connected to said gasifier for recovery of coarse particulates from said hot raw syngas; optionally a heated tar reformer for elimination of tar in said hot raw syngas to provide a hot tar reformer exit syngas; at least one gasifier heat exchanger connected to said gasifier cyclone or said optional hot tar reformer, for cooling of the said hot raw syngas or said hot tar reformer exit syngas to about 200° C. and provide a resultant cool raw syngas; a baghouse or other separation devices for removal of fine particulates from the cool raw syngas and provide a resultant cool syngas; a liquid scrubber or other separation devices for removal of tar and/or moisture from the cool syngas; optionally, an ammonia scrubber or other ammonia separation devices for removal of NH₃ from the cool syngas; optionally, an amine unit or other carbon dioxide separation devices for removal of carbon dioxide from the cool syngas; optionally, a sulfur scrubber or other sulfur separation devices for removal of sulphurous species from the cool syngas; optionally, a chloride scrubber or other chloride separation devices for removal of acid chloride species from the cool syngas; a gas passage with the means to deliver the cool syngas to a kiln burner at ambient temperatures for combustion; at least one char combustor cyclone for recovery of coarse particulates from the char combustor flue gas; at least one char combustor heat exchanger connected to said char combustor cyclone, for cooling of the char combustor flue gas, providing recovered heat and a cool flue gas; a char combustor baghouse or other separation devices to remove fine particulates from the cool flue gas.

According to certain embodiments, the gasifier is a bubbling fluidized bed gasifier.

In certain embodiments, the system further comprises a steam source for the gasifier.

In certain embodiments, the steam to biomass ratio is greater than 0.9 (w/w).

In certain embodiments, the gasifier is operated at 750-850° C.

In certain embodiments, the char combustor is a circulating fluidized bed char combustor comprising one or more stages.

In certain embodiments, the char combustor is operated at 850-950° C.

In certain embodiments, the char combustor utilizes one or more of a stream of organic scrubber liquid with tar, a stream of recycled clean syngas and a stream of biomass as auxiliary fuels.

In certain embodiments, the heat carrier is silica sand, olivine sand, aluminum oxide, or an engineered catalyst.

In certain embodiments, the liquid scrubber utilizes organic solvent or water as a scrubbing liquid.

In certain embodiments, the cool syngas delivered to the kiln burner is free of particulates and tars.

In certain embodiments, the cool syngas contains moisture below 8% vol.

In certain embodiments, the cool syngas contains moisture below 4% vol.

In certain embodiments, the lower heating value of the syngas is a minimum of 9 MJ/Nm³.

In certain embodiments, the system further comprises comprising a dryer, upstream of the gasifier, for reducing the moisture content of the biomass where biomass moisture content exceeds 20%.

In certain embodiments, the dryer utilizes heat recovered from the cooling of the hot raw syngas in the gasifier heat exchanger, and/or heat recovered from the cooling of the char combustor flue gas in the char combustor heat exchanger.

In certain embodiments, the thermal based volumetric flow rate (m³/GJ) of flue gas generated in the kiln burner is no larger than that when the kiln burner is fed with natural gas.

According to a further embodiment of the present invention is provided a method of manufacturing a renewable fuel gas for use in a rotary kiln or in a limestone calcination plant, comprising: partially oxidizing a biomass in a gasifier to generate a hot raw syngas and char; burning said char in a char combustor to generate a char combustor flue gas and energy for the gasification process; circulating heat and char between said gasifier and said char combustor with a heat carrier; recovering coarse particulates from the hot raw syngas utilizing a gasifier cyclone; optionally reforming the tars in the hot raw syngas to provide a hot syngas; cooling the hot raw syngas or hot syngas to about 200° C. in a gasifier heat exchanger resulting in a cool raw syngas and heat; removing fine particulates from the cool raw syngas utilizing a baghouse or other separation devices, resulting in a cool syngas; removing tar and/or moisture from the cool syngas with a liquid scrubber or other separation devices; optionally, removing NH₃ from the cool syngas with an ammonia scrubber or other ammonia separation devices; optionally, removing carbon dioxide from the cool syngas with an amine unit or other carbon dioxide separation devices; optionally, removing sulphurous species from the cool syngas with a sulfur scrubber or other sulfur separation devices; optionally, removing acid chloride species from the cool syngas with a chloride scrubber or other chloride separation devices; delivering the resultant cool syngas to a kiln burner at ambient temperature through a gas passage for combustion in said kiln burner; recovering coarse particulates from the char combustor flue gas in a char combustor cyclone; cooling the char combustor flue gas in a char combustor heat exchanger, resulting in a cool flue gas and heat; removing fine particulates from the cool flue gas in a char combustor baghouse or other separation devices.

In certain embodiments, the gasifier is a bubbling fluidized bed gasifier.

In certain embodiments, the method further comprises feeding steam to the gasifier for use in the oxidizing step.

In certain embodiments, the steam to biomass ratio is greater than 0.9 (w/w).

In certain embodiments, the gasifier is operated at 750-850° C.

In certain embodiments, the char combustor is a circulating fluidized bed char combustor comprising one or more stages.

In certain embodiments, the char combustor is operated at 850-950° C.

In certain embodiments, the char combustor utilizes one or more of a stream of organic scrubber liquid with tar, a stream of recycled clean syngas and a stream of biomass as auxiliary fuels.

In certain embodiments, the heat carrier is silica sand, olivine sand, aluminum oxide, or an engineered catalyst.

In certain embodiments, the liquid scrubber utilizes organic solvent or water as a scrubbing liquid.

In certain embodiments, the cool syngas delivered to the kiln burner is free of particulates and tars.

In certain embodiments, the cool syngas contains moisture below 8% vol.

In certain embodiments, the cool syngas contains moisture below 4% vol.

In certain embodiments, the lower heating value of the syngas is a minimum of 9 MJ/Nm³.

In certain embodiments, the method further comprises drying the biomass to reduce the moisture content of the biomass prior to oxidizing the biomass in the gasifier, in situations where biomass moisture content exceeds 20%.

In certain embodiments, the dryer utilizes heat recovered from the cooling of the hot raw syngas in the gasifier heat exchanger, and/or heat recovered from the cooling of the char combustor flue gas in the char combustor heat exchanger.

In certain embodiments, the volumetric flow rate of flue gas generated in the kiln burner is no larger than that when the kiln burner is fed with natural gas.

### BRIEF DESCRIPTION OF DRAWINGS

In the following, the invention will be described in more detail with reference to the appended drawings, in which:

FIG. 1 shows a schematic representation of a prior art rotary lime kiln.

FIG. 2 shows a schematic process flow diagram of an embodiment of the process for the replacement of fossil fuels in the firing of rotary lime kilns according to the present invention.

FIG. 3 shows a schematic process flow diagram of a further embodiment of the process according to the present invention.

For the sake of clarity, the drawings only show the details necessary for understanding the invention. The structures and details that are not necessary for understanding the invention but would be understood to a person skilled in the art have been omitted in the figures in order to emphasize the characteristics of the invention.

### DETAILED DESCRIPTION OF INVENTION

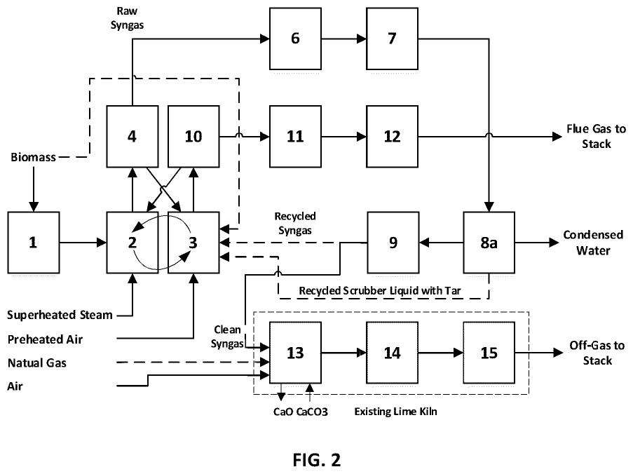

FIG. 2 illustrates a simplified flow diagram for the generation and purification of the medium Btu renewable fuel gas and its application in the lime kiln, according to one embodiment of the present invention. In this embodiment, the woody biomass waste, such as bark or sawdust (labelled BIOMASS in FIG. 2), is gasified in a steam-blown indirect gasification system, including a bubbling fluidized bed (BFB) gasifier 2 and a circulating fluidized bed (CFB) riser combustor 3. The configuration of the BFB gasifier 2 and CFB riser combustor 3 can be configured generally as described previously In the art, including for example, in our previous patent publications WO 2012/065272, U.S. Pat. No. 9,364,812, and U.S. provisional patent application 63/298,990, all incorporated herein by reference. Heat carrier (not shown), such as olivine sand, silica sand, aluminum oxide or engineered catalyst, is re-circulated between the BFB gasifier 2 and the CFB combustor 3—heated in CFB combustor 3 and releasing heat in BFB gasifier 2.

Optionally, and preferably for biomass with moisture content significantly exceeding 20%, the wet biomass may be dried before being fed to the BFB gasifier 2, for example and as shown in a belt dryer 1, preferably to roughly 18% or less moisture content. The belt dryer 1 may use air preheated with the heat recovered within the system, from flue gas and syngas cooling, or indirectly with hot water heated from the same source. For certain biomass, a dryer may not be required, in which case sized and pre-dried biomass may be fed directly into gasifier 2, which is operated under bubbling fluidization conditions, typically at a superficial gas velocity of 0.2-0.5 m/s and a temperature of 750-850° C. and pressure of about 23 psia.

Super-heated steam generated using the heat recovered from syngas and flue gas cooling enters the bottom of gasifier 2 at about 200° C. A moderately high H₂ content and H₂/CO ratio improve flame stability when the gas is burned in the kiln. This is achieved by operating the gasifier at relatively high steam/biomass mass ratios. It is found beneficial to operate the gasifier at a Steam/Biomass mass ratio of around unity. H₂ increases and CO decreases with increasing steam/biomass ratio, leading to an increase in the H₂/CO ratio. The maximum H₂ yield could be reached at an increased steam/biomass mass ratio. It is noted that other Prior Art medium BTU gasifiers, which have been used for combined heat and power applications but not for rotary lime kilns, are operated at much lower steam/biomass ratios of 0.4 to 0.7.

The heat carrier, of the size of about 100 to 300 μm, flows from the combustor cyclones into the BFB gasifier 2 bed at 900° C. to provide heat for the gasification. Raw product gas exits the BFB gasifier 2 and passes through the gasifier cyclone 4 to remove coarse entrained solids. The product gas is then cooled to about 180° C. in heat exchanger 6. The heat from hot syngas can be used for steam generation, which can be used to heat BFB gasifier 2. The cooled product gas enters a baghouse 7 and/or a filter (not shown) to remove the remaining fine ash.

The CFB riser combustor 3 is connected to BFB gasifier 2 by non-mechanical devices at the top and the bottom, as described in U.S. provisional application 63/298,990, incorporated herein by reference. In certain embodiments, the non-mechanical device connected to the top of combustor 3 is a standpipe with a loop-seal or an L-valve to the gasifier 2. In other embodiments, the non-mechanical device connected to the bottoms of gasifier 2 and combustor 3 is a U-bend. CFB combustor 3 operates in fast fluidization with a superficial gas velocity of ˜5-m/s and a top temperature of about 930° C. To heat the sand particles transferred from the gasifier 2, it burns the char particles and auxiliary fuels. The auxiliary fuel comprises one or more of a stream of recycled tar with some contaminated scrubber liquid, a stream of recycled clean syngas, and a stream of biomass. The CFB combustor 3 may also include a second stage (not shown) to ensure complete combustion of the char. Air for CFB combustor 3 is pre-heated, typically utilizing heat recovered from flue gas cooling. The flue gas exiting the combustor cyclone 10 is cooled by passing through heat exchangers 11. The cooled flue gas flows through a baghouse 12 to remove fine particles and then to the stack.

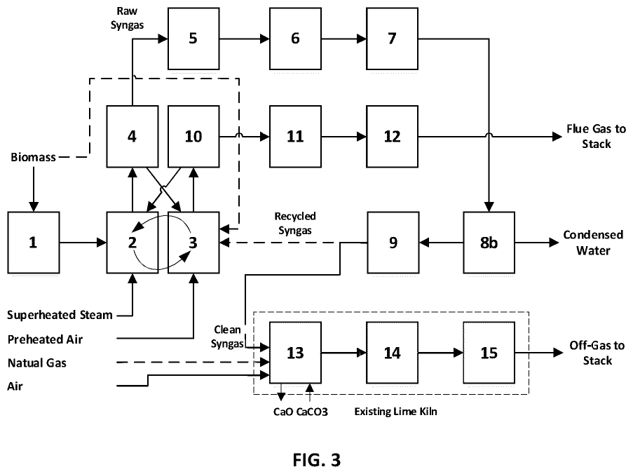

The syngas from baghouse 7 enters scrubber 8a, contacting with cold organic scrubbing liquid to remove the tar and condense most steam in syngas. Alternatively, the tar may be removed by a reformer (FIG. 3) followed by a Venturi scrubber 8b using water instead of organic solvent. After the scrubber 8a or 8b, the syngas may be purified with some optional processes represented by element 9, which may include
(1) NH₃ removal to reduce NOₓ emissions,
(2) chloride removal to mitigate facility corrosion,
(3) H₂S removal in the case of pellet lime kilns to remove sulfur and therefore avoid resultant sulphur contamination of the product CaO,
(4) CO₂ removal to increase the RFG heating value and adiabatic flame temperature, and potentially reduce the GHG emissions with CO₂ sequestration or utilization processes.

Finally, the clean syngas is cooled to ambient temperature (˜25° C.) or lower to reduce the syngas moisture content to about 3% and sent to lime kiln 13, and to combustor 3 if needed to heat the recirculating heat carrier in the combustor 3.

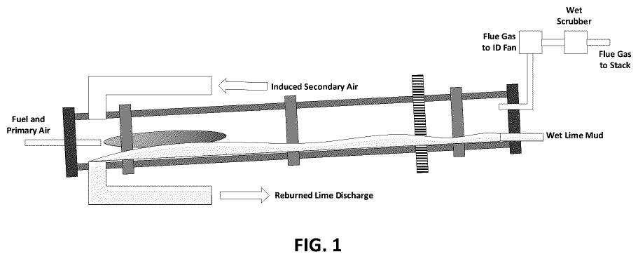

The lime kiln itself, and the equipment downstream thereof, can be a typical prior art rotary kiln arrangement as described in FIG. 1, or may be any other type of rotary lime kiln, or stationary vertical lime kiln.

The syngas is burned in the lime kiln 13 for calcination. The off-gas is drawn out of the kiln by the ID fan 14 to the dust scrubber 15 for cleanup and then to the stack. The adiabatic flame temperature with the medium-Btu syngas utilizing this method is substantially equal to that with natural gas under the same burner conditions (Table 1), which means the syngas can be delivered to the burner at ambient temperatures (25° C.) without sacrificing the adiabatic flame temperature. Furthermore, the matching of thermal based flue gas volumetric flow rates (m3/GJ) enables the same fan and dust scrubber to be used after the change in fuel from natural gas to the clean syngas of this invention.

Low-temperature syngas allows more gas cleanup procedures to remove one or more of the syngas particulates, tar, NH₃, most moisture, H₂S, chlorides and CO₂. Drawback 1 is at least partially overcome.

A large amount of energy can be recovered during the syngas and char combustor flue gas cooling by a variety of means including thermal oil or steam, which can be used to produce steam for gasifier 2 and preheat air for combustor 3 or feed dryer 1. In the event that the moisture content of the biomass is below a certain level (e.g., 22%,) a dryer 1 may not be needed. In a separate embodiment, the thermal oil loop can be replaced by a more conventional water/air cooling system. Typically, the waste heat from syngas and combustor flue gas is sufficient for the feedstock dryer 1 and steam generator (not shown) feeding superheated steam to gasifier 2. Thus less or no fossil fuels or extra biomass are needed, which at least partially overcomes Drawback 4.

The retrofitting of existing natural gas fired lime kilns is dramatically simplified with the hereindescribed system and method. The thermal based volumetric flow rate of the kiln flue gas with the syngas of the invention is only slightly lower than that with natural gas, which means neither the ID fan nor the dust scrubber is required to be re-sized to maintain the original lime kiln capacity. Low-temperature syngas transport from the gasifier unit to the lime kiln means the pipeline material used for natural gas will also serve for the syngas, and replacement by high-grade materials is not needed. Meanwhile, the gasification plant doesn't have to be located near the kiln to minimize heat loss, which means more choices in the location of the gasifier. These features help avoid Drawbacks 2, 3, 5 and 6.

With the advantages of the invention mentioned above, natural gas can be entirely replaced with syngas of the invention without jeopardizing the kiln throughput or the quality of the lime, or significant retrofitting, which decreases the capital cost and increases the environmental benefit. Drawback 7 is overcome.

Example 1: Table 2 shows how renewable HEI syngas can meet the conditions to replace fossil natural gas in a lime-mud kiln in the pulp and paper industry. HEI syngas has an LHV value of ˜11 MJ/m³, giving an adiabatic flame temperature essentially the same as natural gas (within 5° C.), and has a slightly lower flue gas volume/GJ than a kiln that uses natural gas.

Table 2 compares the representative properties and combustion performance of different fuel gases for lime kiln applications.

TABLE 2
Comparison of Representative Properties of Natural Gas, Medium-
Btu Syngas of this Invention and Low-Btu Syngas of the Prior Art

| | Fuel Gas | | |
|---|---|---|---|
| | | Present | Prior Art |
| | | Invention | Low-Btu |
| | Natural | Medium-Btu | Syngas |
| | Gas | Syngas | [11] |
| LHV (MJ/Nm³) | 37.0 | 10.8 | 5.3 |
| Moisture (% mol) | 0.002-0.004¹ | 3.1 | 15 |
| Adiabatic Flame | 1,920^{3, 5} | 1,920^{3, 5} | 1,520^{3, 5} |
| Temperature (° C.)² | | | 1,920^{3, 5} |
| Fuel flow rate (Nm³/GJ) | 27 | 93 | 189 |
| Air/fuel Ratio (v/v) | 10.8 | 2.6 | 1.3 |
| Flue gas flow rate (Nm³/GJ) | 289 | 277 | 368 |

¹dry natural gas before moisturization and odorization
²10% excess air
³The fuel gas and combustion air are delivered to the burner at 25° C.
⁴The fuel gas and combustion air are delivered to the burner at 700° C. and 350° C., respectively.
⁵The adiabatic flame temperature values are rounded off to the nearest 10 degrees.

Example 2: Table 3 shows the impact of gasification operating conditions on the syngas compositions and combustion properties. Case 1 is a typical operation of this invention. The feed biomass is gasified at 830° C., with olivine sands as the gasifier bed heat carrier material. Case 1a is Case 1 with 90% CO₂ removal from the syngas, resulting in higher syngas LHV and adiabatic flame temperature, and lower thermal based flue gas volumetric flow rate. Running the gasifier at a lower temperature with the same bed heat carrier material in the gasifier (Cases 2-3 and 5-6) will increase the syngas LHV and adiabatic flame temperature as the methane content in the syngas is raised, and vice versa (Case 4). At the same gasifier temperature, replacing semi-catalyst olivine sands with non-catalytic silica sands as the heat carrier particles in the gasifier system (Cases 5-6) raises the syngas LHV and adiabatic flame temperature. However, olivine sands, while giving slightly lower LHV and adiabatic flame temperature than with silica sand, catalyze tar reforming reactions, reducing tar concentration and associated operating problems. Similarly, reforming catalyst as the gasifier bed will decrease the syngas LHV and adiabatic flame temperature (Case 12 vs. 11) as the CH₄ content decreases. Likewise, downstream reforming or water-gas shift process will reduce the syngas LHV and adiabatic flame temperature (Cases 7-10).

Example 3: Cases 1-7 and 9-10 in Table 3 all give syngas adiabatic flame temperatures over 1900° C. and flue gas flow rates below 280 Nm³/GJ, indicating suitability for replacing fossil natural gas. From the published literature, the composition of syngases from three competing companies designated here as S, N and E were used to calculate their LHV and adiabatic flame temperature values (Table 4). It is noted that syngases from gasifiers S and N contain substantial percentages of nitrogen (being in part air-blown gasifiers), leading to flame temperatures of 1,675 and 1,439° C., respectively. These would not meet the criteria of the flame temperature (1,750° C.). Similarly, Gasifier E, which has a high concentration of CO₂ but a low concentration of N₂, would not match the adiabatic flame temperature of any of the HEI syngases in Table 3. The syngas with high inert N₂ or CO₂ also causes flue gas flow rates over 300 Nm³/GJ.

TABLE 3
Impact of Operating Conditions on the Syngas Compositions and Combustion Properties

| | Operating Conditions | | | | | | | | | |
|---|---|---|---|---|---|---|---|---|---|---|
| | (Gasifier | | | | | | | | | |
| | Temperature, Bed | | | | | | | | | |
| Case | Material, and | Syngas Composition, mol % | | | | | | LHV | AFT¹ | Flue gas¹ |
| No. | Further Steps) | H₂ | CO | CH₄ | CO₂ | N₂ | H₂O | (MJ/m³) | (° C.) | (Nm³/GJ) |
| 1 | 830° C., olivine | 40.5 | 27.5 | 8.2 | 18.2 | 2.4 | 3.1 | 10.8 | 1,919 | 277 |
| 1a | 830° C., olivine 90% CO2 removal | 49.0 | 33.3 | 9.9 | 2.2 | 2.4 | 3.1 | 13.1 | 2,051 | 262 |
| 2 | 750° C., olivine | 36.0 | 31.2 | 10.0 | 17.2 | 2.4 | 3.1 | 11.4 | 1,929 | 277 |
| 3 | 800° C., olivine | 38.8 | 28.9 | 9.1 | 17.7 | 2.4 | 3.1 | 11.1 | 1,924 | 277 |
| 4 | 850° C., olivine | 40.9 | 27.2 | 7.9 | 18.4 | 2.4 | 3.1 | 10.7 | 1,917 | 277 |
| 5 | 800° C., silica | 29.4 | 39.9 | 11.2 | 13.9 | 2.4 | 3.1 | 12.3 | 1,965 | 274 |
| 6 | 850° C., silica | 32.9 | 36.8 | 10.1 | 14.6 | 2.4 | 3.1 | 11.8 | 1,958 | 274 |
| 7 | 830° C., olivine with downstream | 48.2 | 25.0 | 3.5 | 17.8 | 2.4 | 3.1 | 9.6 | 1,929 | 272 |
| | tar reforming | | | | | | | | | |
| 8 | 830° C., olivine with downstream | 43.5 | 20.7 | 7.8 | 22.4 | 2.4 | 3.1 | 10.1 | 1,870 | 282 |
| | water-gas shifting | | | | | | | | | |
| 9 | 830° C., silica | 34 | 35 | 13 | 18 | 0 | 0 | 12.8 | 1,956 | 274 |
| 10 | 830° C., silica with downstream | 60.8 | 18.5 | <0.2 | 20.6 | 0 | 0 | 8.9 | 1,942 | 265 |
| | tar & methane reforming | | | | | | | | | |
| 11 | Gasification with sand as the bed | 36.5 | 34.4 | 11.5 | 13.5 | 0 | 0 | 14.9 | 2,012 | 269 |
| | material² | | | | | | | | | |
| 12 | Gasification with reforming catalyst | 60.6 | 10.6 | 3.2 | 25.5 | 0 | 0 | 9.0 | 1,870 | 275 |
| | as the bed material² | | | | | | | | | |

¹Adiabatic flame temperature, 10% excess air; fuel gas and air at 25° C.
²bio-oil as gasifier feedstock; Syngas contains 4.2 mol % C₂H₄.
³bio-oil as gasifier feedstock

TABLE 4
Fuel Gas Compositions and Combustion Properties from Published Literature

| Case | Types of | Fuel Gas Composition, mol % | | | | | | LHV | AFT¹ | Flue gas¹ |
|---|---|---|---|---|---|---|---|---|---|---|
| No. | Fuel Gas | H₂ | CO | CH₄ | CO₂ | N₂ | H₂O | (MJ/m³) | (° C.) | (Nm³/GJ) |
| 13 | S Gas | 21.4 | 24.2 | 0.1 | 10.2 | 43.2 | 0 | 5.7 | 1,675 | 334 |
| 14 | N Gas² | 8.0 | 20.1 | 2.0 | 12.0 | 57.2 | 0 | 4.1 | 1,439 | 405 |
| 15 | E Gas | 25.3 | 22.2 | 7.1 | 41.4 | 4.0 | 0 | 8.1 | 1,686 | 310 |
| 16 | Producer Gas³ | 15.9 | 25.1 | 2.0 | 6.3 | 50.3 | 0 | 5.6 | 1,667 | 342 |
| 17 | Blast Gas | 1.0 | 27.5 | 0 | 11.5 | 60.0 | 0 | 3.6 | 1,371 | 443 |

¹Adiabatic flame temperature, 10% excess air; fuel gas and air at 25° C.
²Containing 0.7 mol % O₂
³Containing 0.4 mol % O₂

### REFERENCES

### (All Incorporated Herein by Reference)

1. Rey, J. R. C., D. T. Pio, and L. A. C. Tarelho, Biomass direct gasification for electricity generation and natural gas replacement in the lime kilns of the pulp and paper industry: A techno-economic analysis. Energy, 2021. 237: p. 121562.
2. Tran, H., Lime Kiln Chemistry and Effects on Kiln Operations, in TAPPI Kraft Recovery Course, H. Tran, Editor. 2008, TAPPI: St. Petersburg, Florida, USA. p. 1-9.
3. Francey, S., H. Tran, and A. Jones, Current status of alternative fuel use in lime kilns. TAPPI Journal, 2009. 8(9): p. 7.
4. Syamsudin and H. Susanto, STUDY ON ALTERNATIVE FUELS FOR LIME KILN IN A KRAFT PULP MILL VIA DIRECT COMBUSTION AND GASIFICATION. 2016, 2016. 3(01).
5. Adams, T. N., Lime Kiln Principles and Operations, in TAPPI Kraft Recovery Course, H. Tran, Editor. 2008, TAPPI: St. Petersburg, Florida, USA. p. 15.
6. Taillon, J., A. Horváth, and A. Oksman, Replacement of fossil fuel with biomass in pulp mill lime kilns. O Papel, 2018. 79: p. 85-89.
7. Miner, R. and B. Upton, Methods for estimating greenhouse gas emissions from lime kilns at kraft pulp mills. Energy, 2002. 27(8): p. 729-738.
8. Kuparinen, K., E. Vakkilainen, and M. Hamaguchi. Analysis on fossil fuel free operation in a northern pulp and paper mill. in 2017 International Chemical Recovery Conference. 2017. Halifax, Canada.
9. Francey, S., H. Tran, and A. Jones, Current Status of Alternative Fuel Use in Lime Kilns. TAPPI Journal, 2009: p. 7.
10. Berglin, N. and A. V. Schenck, Biofuels In Lime Kilns: Operating experience in the Nordic pulp and paper industry. 2022, Energiforsk AB. p. 50.
11. Rofouieeraghi, P., Biomass Gasification Integrated into a Reference Canadian Kraft Mill, in ÉCOLE POLYTECHNIQUE DE MONTRÉAL. 2012, UNIVERSITÉ DE MONTRÉAL. p. 108.

1. A system for manufacturing of a renewable fuel gas for use in a rotary lime kiln or in a limestone calcination plant, comprising:
a dual bed gasification apparatus, said dual bed gasification apparatus comprising:
a gasifier, such as a bubbling fluidized bed gasifier, providing partial oxidation of a biomass to generate a hot raw syngas and char;
a char combustor, such as a circulating fluidized bed char combustor comprising one or more stages, connected to the gasifier generating a char combustor flue gas and providing energy for the gasification process;
a heat carrier circulating between the said gasifier and char combustor to transfer heat from the char combustor to the gasifier;
at least one gasifier cyclone, connected to said gasifier for recovery of coarse particulates from said hot raw syngas;
optionally a heated tar reformer for elimination of tar in said hot raw syngas to provide a hot tar reformer exit syngas;
at least one gasifier heat exchanger connected to said gasifier cyclone or said optional hot tar reformer, for cooling of the said hot raw syngas or said hot tar reformer exit syngas to about 200° C. and provide a resultant cool raw syngas;
a baghouse or other separation devices for removal of fine particulates from the cool raw syngas and provide a resultant cool syngas;
a liquid scrubber or other separation devices for removal of tar and/or moisture from the cool syngas;
optionally, an ammonia scrubber or other ammonia separation devices for removal of NH₃ from the cool syngas;
optionally, an amine unit or other carbon dioxide separation devices for removal of carbon dioxide from the cool syngas;
optionally, a sulfur scrubber or other sulfur separation devices for removal of sulphurous species from the cool syngas;
optionally, a chloride scrubber or other chloride separation devices for removal of acid chloride species from the cool syngas;
a gas passage with the means to deliver the cool syngas to a kiln burner at ambient temperatures for combustion;
at least one char combustor cyclone for recovery of coarse particulates from the char combustor flue gas;
at least one char combustor heat exchanger connected to said char combustor cyclone, for cooling of the char combustor flue gas, providing recovered heat and a cool flue gas;
a char combustor baghouse or other separation devices to remove fine particulates from the cool flue gas.

2. (canceled)

3. A system according to claim 1, further comprising a steam source for the gasifier, wherein steam to biomass ratio is greater than 0.9 (w/w).

4. (canceled)

5. A system according to claim 1, wherein the gasifier is operated at 750-850° and/or the char combustor is operated at 850-950° C.

6. (canceled)

7. (canceled)

8. A system according to claim 1, wherein the char combustor utilizes one or more of a stream of organic scrubber liquid with tar, a stream of recycled clean syngas and a stream of biomass as auxiliary fuels.

9. (canceled)

10. (canceled)

11. A system according to claim 1, wherein the cool syngas delivered to the kiln burner is free of particulates and tars.

12. A system according to claim 11, wherein the cool syngas contains moisture below 8% vol, for example, below 4% vol.

13. (canceled)

14. A system according to claim 11, wherein the lower heating value of the syngas is a minimum of 9 MJ/Nm³.

15. A system according to claim 1, further comprising a dryer, upstream of the gasifier, for reducing the moisture content of the biomass where biomass moisture content exceeds 20%.

16. A system according to claim 15, wherein the dryer utilizes heat recovered from the cooling of the hot raw syngas in the gasifier heat exchanger, and/or heat recovered from the cooling of the char combustor flue gas in the char combustor heat exchanger.

17. A system according to claim 1, wherein the thermal based volumetric flow rate (m³/GJ) of flue gas generated in the kiln burner is no larger than that when the kiln burner is fed with natural gas.

18. A method of manufacturing a renewable fuel gas for use in a rotary kiln or in a limestone calcination plant, comprising:
partially oxidizing a biomass in a gasifier, such as a bubbling fluidized bed gasifier, to generate a hot raw syngas and char;
burning said char in a char combustor, such as a circulating fluidized bed char combustor comprising one or more stages, to generate a char combustor flue gas and energy for the gasification process;
circulating heat and char between said gasifier and said char combustor with a heat carrier;
recovering coarse particulates from the hot raw syngas utilizing a gasifier cyclone;
optionally reforming the tars in the hot raw syngas to provide a hot syngas;
cooling the hot raw syngas or hot syngas to about 200° C. in a gasifier heat exchanger resulting in a cool raw syngas and heat;
removing fine particulates from the cool raw syngas utilizing a baghouse or other separation devices, resulting in a cool syngas;
removing tar and/or moisture from the cool syngas with a liquid scrubber or other separation devices;
optionally, removing NH₃ from the cool syngas with an ammonia scrubber or other ammonia separation devices;
optionally, removing carbon dioxide from the cool syngas with an amine unit or other carbon dioxide separation devices;
optionally, removing sulphurous species from the cool syngas with a sulfur scrubber or other sulfur separation devices;
optionally, removing acid chloride species from the cool syngas with a chloride scrubber or other chloride separation devices;
delivering the resultant cool syngas to a kiln burner at ambient temperature through a gas passage for combustion in said kiln burner;
recovering coarse particulates from the char combustor flue gas in a char combustor cyclone;
cooling the char combustor flue gas in a char combustor heat exchanger, resulting in a cool flue gas and heat;
removing fine particulates from the cool flue gas in a char combustor baghouse or other separation devices.

19. (canceled)

20. The method according to claim 18, further comprising feeding steam to the gasifier for use in the oxidizing step, wherein the steam to biomass ratio is greater than 0.9 (w/w).

21. (canceled)

22. The method according to claim 18, wherein the gasifier is operated at 750-850° C. and/or the char combustor is operated at 850-950° C.

23. (canceled)

24. (canceled)

25. The method according to claim 18, wherein the char combustor utilizes one or more of a stream of organic scrubber liquid with tar, a stream of recycled clean syngas and a stream of biomass as auxiliary fuels.

26. (canceled)

27. (canceled)

28. The method according to claim 18, wherein the cool syngas delivered to the kiln burner is free of particulates and tars.

29. The method according to claim 28, wherein the cool syngas contains moisture below 8% vol, for example, below 4% vol.

30. (canceled)

31. The method according to claim 28, wherein the lower heating value of the syngas is a minimum of 9 MJ/Nm³.

32. The method according to claim 18, further comprising drying the biomass to reduce the moisture content of the biomass prior to oxidizing the biomass in the gasifier, in situations where biomass moisture content exceeds 20%.

33. The method according to claim 32, wherein the dryer utilizes heat recovered from the cooling of the hot raw syngas in the gasifier heat exchanger, and/or heat recovered from the cooling of the char combustor flue gas in the char combustor heat exchanger.

34. The method according to claim 18, wherein the volumetric flow rate of flue gas generated in the kiln burner is no larger than that when the kiln burner is fed with natural gas.
